(19) United States
(12) Patent Application Publication
(10) Pub. No.: US 2011/0143603 A1
(43) Pub. Date: Jun. 16, 2011

(54) Connector structure

(75) Inventors: Rui-Hong Huang, Hukou Township (TW); Kuang-Hua Shiu, Hukou Township (TW)

(73) Assignee: Singatron Enterprise Co., Ltd.

(21) Appl. No.: 11/812,975

(22) Filed: Jun. 22, 2007

(51) Int. Cl. H01R 33/72

(52) U.S. Cl. 439/675

(57) ABSTRACT

The present invention provides an improved connector structure, structured to include a covering case, a first base, a second base, a first conducting terminal, a second conducting terminal and a third conducting terminal, in which a plurality of first contact pins extend from the main body of the first conducting terminal, and is disposed in a holding space of the first base. A plurality of second contact pins extend from the main body of the second conducting terminal, and together with the third conducting terminal is disposed in a holding space of the second base, thereby enabling achieving supplying electric power requirements. Furthermore, an outer portion of the connector is covered with a covering case.

### BACKGROUND OF THE INVENTION

(a) Field of the Invention

The art of the present invention provides an improved connector structure, wherein a plurality of first contact pins and second contact pins respectively extend from the main body of a first conducting terminal and a second conducting terminal. Moreover, the first conducting terminal is disposed within a first holding space of a first base, and the second conducting terminal together with a third conducting terminal are disposed within a second holding space of a second base, thereby achieving convenience of assembly and better conducting effectiveness when in use.

(b) Description of the Prior Art

Conducting terminals of a conventional connector are made up from a plurality of contact pins, and assembly of the connector involves intricate steps; in addition to having a manufacturing cost. Moreover, because the conducting terminals need to be fabricated from a plurality of contact pins and disposed within bases, and because a covering case covering the conducting terminals lacks any special clasping structure, consequently, the conventional connector easily creates apprehension over the conducting terminals coming apart under long term usage, causing the contact pins to have poor electrical contact because of poor flatness and the covering case to have poor joining effectiveness.

Hence, the inventor of the present invention proposes to resolve and surmount existent technical difficulties to eliminate the aforementioned shortcomings of prior art.

### SUMMARY OF THE INVENTION

The art of the present invention provides an improved connector structure, wherein a plurality of first contact pins and second contact pins respectively extend from the main body of a first conducting terminal and a second conducting terminal. Moreover, the first conducting terminal is disposed within a first holding space of a first base, and the second conducting terminal together with a third conducting terminal are disposed within a second holding space of a second base, thereby achieving convenience of assembly and better conducting effectiveness when in use. Furthermore, the second base is joined to the first base using clasp bodies clasped into holes of the first base. A covering case covers the first base and the second base, and a plurality of clasp strips extending from the main body of the covering case embed into clasp grooves of the first base.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of the present invention.

FIG. 2 shows an exploded elevational view of the present invention.

FIG. 3 shows a first schematic view of an embodiment according to the present invention.

FIG. 4 shows a second schematic view of the embodiment according to the present invention.

FIG. 5 shows a third schematic view of the embodiment according to the present invention.

### DETAILED DESCRIPTION OF THE PREFERRED EMBODIMENTS

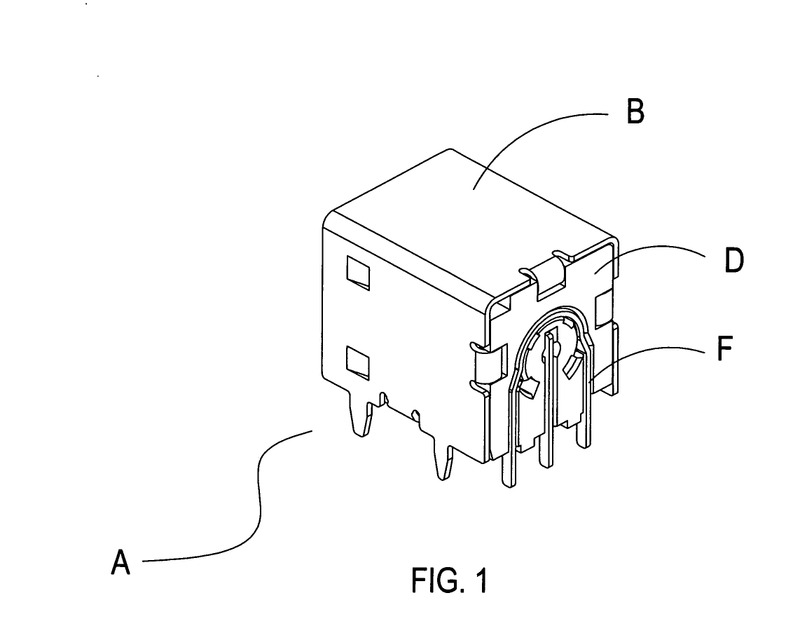

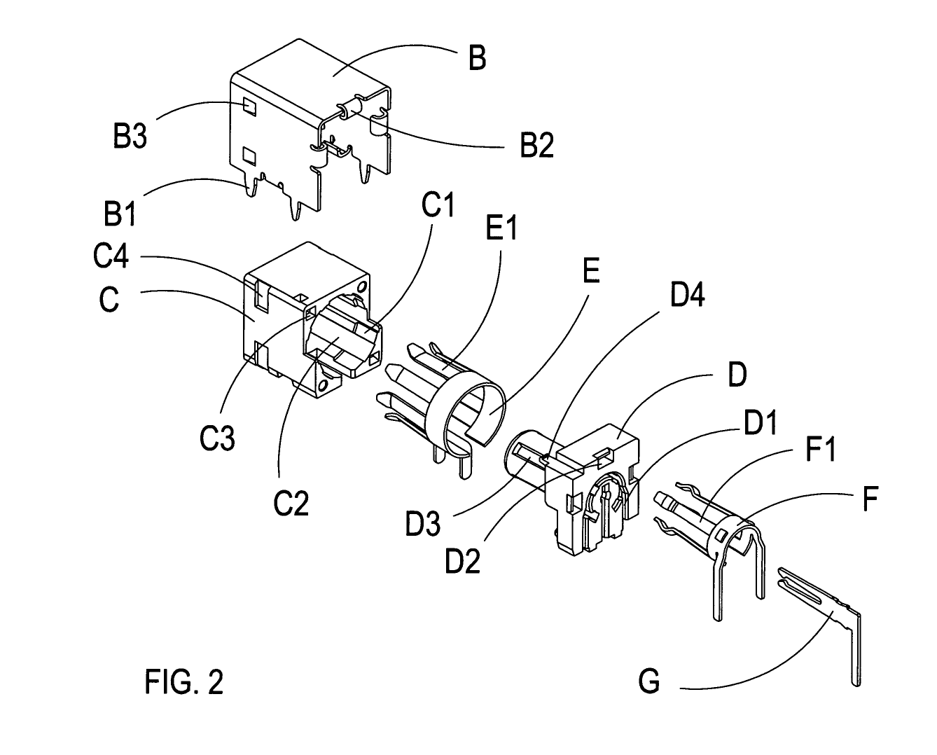

Referring to FIG. 1 and FIG. 2, which show an improved connector structure of the present invention, wherein a connector A is structured to comprise a covering case B, a first base C, a second base D, a first conducting terminal E, a second conducting terminal F and a third conducting terminal G.

The first conducting terminal E of the connector A is configured with a plurality of first contact pins E1 extending from the main body thereof, and is disposed within a first holding space C1 of the first base C. Moreover, the first contact pins E1 are disposed in first holding grooves C2. The second conducting terminal F is configured with a plurality of second contact pins F1 extending from the main body thereof, and together with the third conducting terminal G is disposed within a second holding space D1 of the second base D. The second contact pins F1 are disposed in second holding grooves D3, thereby enabling achieving reliable conducting effectiveness. Clasp bodies D4 of the second base D are used to clasp into holes C3 of the first base C, thereby enabling joining the second base D to the first base. Moreover, the covering case B is used to cover the first base C and the second base D. Soldering portions B1, clasp portions B2 and clasp strips B3 extend from the covering case B, wherein the clasp portions B2 clasp into a groove D2 of the second base D, and the clasp strips B3 embed into clasp grooves C4 of the first base C, thereby increasing covering effectiveness.

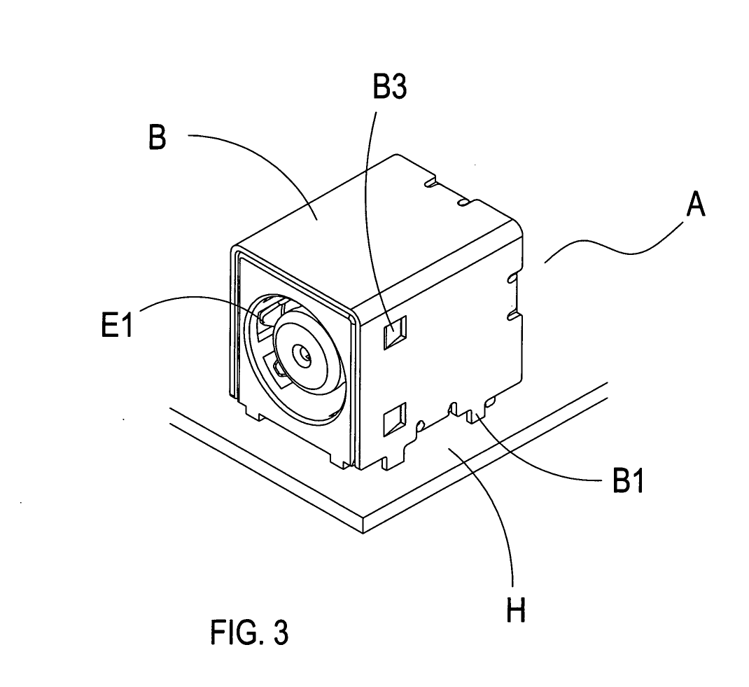

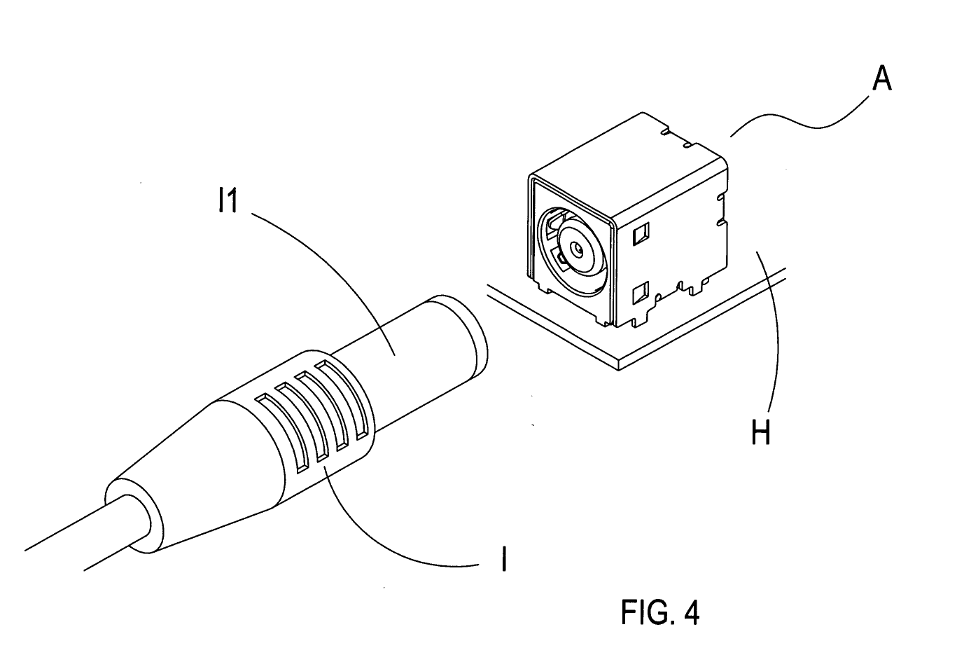

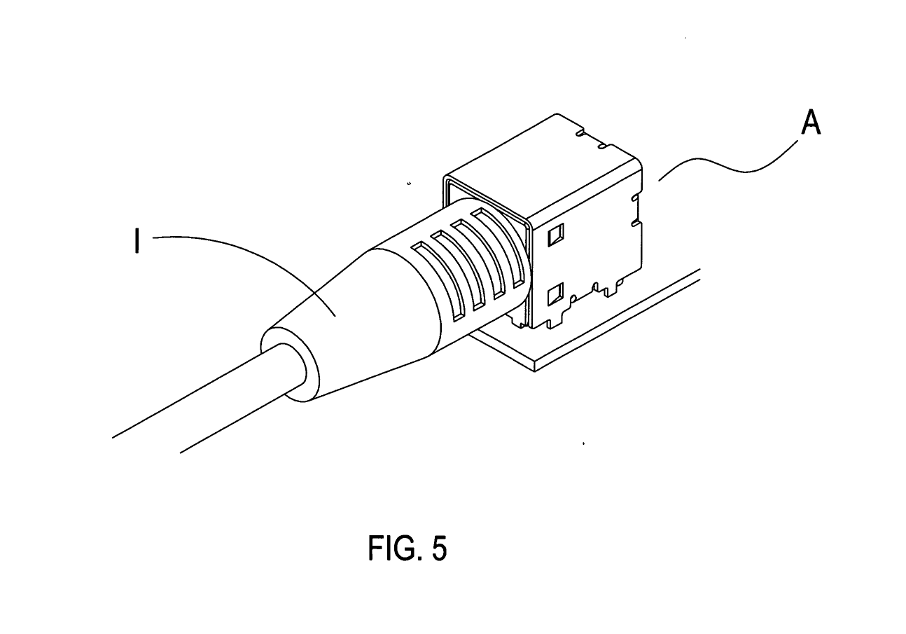

Referring to FIG. 2, FIG. 3, FIG. 4 and FIG. 5, which show an embodiment of the improved connector structure of the present invention, wherein the first conducting terminal E of the connector A is configured with a plurality of the first contact pins E1 extending from the main body thereof, and is disposed within the first holding space C1 of the first base C, moreover, clasps into the first holding grooves C2 defined in the inner wall of the first holding space C1. The second conducting terminal F is configured with a plurality of the second contact pins F1 extending from the main body thereof, and together with the third conducting terminal G is disposed within the second holding space D1 of the second base D, moreover, clasps into the second holding grooves D3 of the second holding space D1. The clasp bodies D4 located on the second base D are then used to clasp into the holes C3 of the first base C, thereby enabling the second base D to be firmly joined to the first base, and the covering case B is used to cover the first base C and the second base D. The clasp portions B2 extending from the covering case B clasp into the groove D2 of the second base D, and the clasp strips B3 extending from the covering case B embed into the clasp grooves C4 of the first base C, thereby enabling strengthening the joining between the first base C to the second base D and making the joint even more stable.

The soldering portions B1 extending from the covering case B are used to solder the connector A to a circuit board H, thereby enabling a conducting end I1 of an electric connector I to be disposed within the connector A, after which the conducting end I1 uses the first conducting terminal E, the second conducting terminal F and the third conducting terminal G to transmit electric power needed by the user.

In order to better explicitly disclose advancement and practicability of the present invention, a comparison with prior art is described hereinafter:

Shortcomings of Prior Art

1. Manufacturing cost is high.

2. Assembly process is intricate and time-consuming.

3. Easily creates apprehension over poor conduction.

Advantages of the Present Invention

1. Reduces manufacturing cost.

2. Assembly is quick and maintenance is convenient.

3. Increases flatness thereby enabling achieving optimum conducting effectiveness.

4. Provided with advancement and practicability.

5. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A connector structure, comprising a covering case, a first base, a second base, a first conducting terminal, a second conducting terminal and a third conducting terminal;
wherein a plurality of first contact pins and second contact pins respectively extend from the main body of a first conducting terminal and a second conducting terminal; the first conducting terminal is disposed within a first holding space of a first base, and a plurality of first holding grooves defined in the inner wall of the first holding space are used to correspondingly hold the plurality of first contact pins; the second conducting terminal is disposed within a second holding space of the second base, and a plurality of second holding grooves extend from the second holding space to correspondingly hold the plurality of second contact pins; holes defined in the first base and a plurality of clasp bodies extending from the second base are used to enable the first base to be joined to the second base, and the first base and the second base are covered using a covering case; a plurality of clasp portions and a plurality of clasp strips extend from the covering case, which are used to clasp into grooves of the second base and clasp grooves of the first base respectively.

2. The connector structure according to claim 1, wherein the third conducting terminal is disposed in the second holding space of the second base.

3. The connector structure according to claim 1, wherein after joining the first base to the second base, the first conducting terminal is positioned outside the second conducting terminal.

4. The connector structure according to claim 1, wherein after joining the first base to the second base, the third conducting terminal is positioned inside the second conducting terminal.

5. The connector structure according to claim 1, wherein soldering portions extending from the covering case are used to fixedly solder to a circuit board.

6. The connector structure according to claim 1, which when disposed in a power supply connector enables achieving functionality to transmit electric power.
